(19) United States
(12) Patent Application Publication
(10) Pub. No.: US 2008/0013067 A1
(43) Pub. Date: Jan. 17, 2008

(54) Exposure Apparatus

(75) Inventor: Yoshiharu Sasaki, Shizuoka-jen (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 11/667,188

(22) PCT Filed: Nov. 4, 2005
(86) PCT No.: PCT/JP05/20679

§ 371 Date: May 7, 2007

(30) Foreign Application Priority Data
Nov. 8, 2004 (JP) 2004-323698

(51) Int. Cl. G03B 27/58

(52) U.S. Cl. 355/72

(57) ABSTRACT

When exposing a predetermined pattern on a photosensitive material of a plate-like laminated body formed by applying a photosensitive film, which is formed of the photosensitive material and a support medium stacked on top of another, on a substrate with the photosensitive material toward the substrate, the reaction of the resist layer with oxygen is minimized. In order to achieve this, a peeling unit (180) for peeling the support medium from the photosensitive material (150) is provided within an exposure apparatus (1), and the predetermined pattern is exposed on the photosensitive material (150) by a scanner (162) immediately after the support medium is peeled from the photosensitive material (150) by the peeling unit (180).

### TECHNICAL FIELD

The present invention relates to an exposure apparatus for exposing a predetermined pattern, such as a wiring pattern of a printed wiring board or the like, on a photosensitive layer of a plate-like laminated body, which includes the photosensitive layer and a support medium stacked on top of another, using a light beam emitted from a laser source or the like.

### BACKGROUND ART

A photosensitive film formed of a photosensitive layer, such as a resist layer, color filter layer, or the like, stacked on a support medium is known. Such a photosensitive film is formed into a plate-like laminated body by applying the film on, for example, a glass substrate, then the support substrate is peeled from the plate-like laminated body, and used in the state in which only the photosensitive layer remaining on the glass substrate.

If, for example, a resist layer is used as the photosensitive layer of the photosensitive film constituting the plate-like laminated body, the support medium is peeled from the plate-like laminated body, and moved to an exposure process in the state in which only the resist layer remaining on the glass substrate. If a color filter layer is used as the photosensitive layer of the photosensitive film constituting the plate-like laminated body, the support medium is peeled from the plate-like laminated body, and moved to the subsequent exposure process in the state in which only the color filter layer remaining on the glass substrate.

Then, photopolymerization reaction takes place in an exposed region of the photosensitive layer exposed by the exposure process, and the photosensitive layer is solidified. Thereafter, a pattern is formed through developing and etching processes.

In the mean time, for the plate-like laminated body in which a support medium (also called as “cover film”, or “protective film”) is stacked on a substrate, the support medium is not required in the exposure process as described above, so that it is necessary to peel it from the plate-like laminated body.

As for the method for peeling the support medium from plate-like laminated body, a method in which the support medium side of a plate-like laminated body being conveyed is adhered to the outer circumference face of an adhesive roll to peel the medium from the plate-like laminated body, and peeled support medium is rolled up around the adhesive roll is known as described, for example, in Japanese Unexamined Patent Publication Nos. 2001-240305 and 6(1994)-282076.

Further, various types of exposure apparatuses for performing image exposure by a light beam, modulated according to image data using a spatial modulation device, such as a digital micro-mirror device (DMD) or the like, are proposed. As one of the applications of such exposure apparatuses, the application to the manufacturing process for printed wiring boards is known as described, for example, in Japanese Unexamined Patent Publication No. 2004-1244.

Once the support medium is peeled from the plate-like laminated body, the photosensitive layer is exposed to the atmosphere, and the photosensitive layer reacts with oxygen. This causes a problem that the photopolymerization reaction of the photosensitive layer is prevented in the exposure process. Therefore, it is necessary to convey the plate-like laminated body to the exposure process as soon as possible once the support medium is peeled by a peeling unit. During the conveyance, however, the plate-like laminated body is inevitably exposed to the atmosphere, so that complete prevention of such reaction of the photosensitive layer with oxygen has not been achieved yet.

### DISCLOSURE OF THE INVENTION

The present invention has been developed in view of the circumstances described above, and it is an object of the present invention to minimize the reaction with oxygen of the photosensitive layer of a plate-like laminated body peeled of the support medium.

The exposure apparatus of the present invention is an apparatus, including:

an exposure means for exposing a predetermined pattern on a photosensitive layer of a plate-like laminated body formed by applying a photosensitive film, which is formed of the photosensitive layer and a support medium stacked on top of another, on a substrate with the photosensitive layer toward the substrate;

a conveyor means for conveying the plate-like laminated body to the exposure means along a predetermined conveying path; and

a peeling means, provided upstream of the exposure means in the predetermined conveying path, for peeling the support medium from the plate-like laminated body.

The exposure apparatus of the present invention may further include an oxygen pressure reducing means for reducing the oxygen pressure adjacent to the photosensitive layer, after the support medium is peeled therefrom, to less than or equal to 80% of the atmospheric oxygen pressure.

In this case, the oxygen pressure reducing means may be a means for reducing the air pressure within the apparatus.

Alternatively, the oxygen pressure reducing means may be a means for jetting an inert gas toward the plate-like laminated body.

According to the present invention, the peeling means for peeling the support medium from a plate-like laminated body is provided upstream of the exposure means in the exposure apparatus, so that the plate-like laminated body peeled of the support medium is conveyed to the exposure means immediately. This may minimize the time the plate-like laminated body peeled of the support medium is exposed to the atmosphere. As a result, the reaction of the photosensitive layer with oxygen may be minimized. Thus, degradation in sensitivity of the photosensitive layer to light may be prevented, and a pattern exposure may be performed satisfactorily.

In particular, by reducing the oxygen pressure adjacent to the photosensitive layer, after the support medium is peeled therefrom, to less than or equal to 80% of the atmospheric oxygen pressure, the reaction of the photosensitive layer with oxygen may be reduced further.

### BRIEF DESCRIPTION OF DRAWINGS

FIG. 1 is a perspective view of the exposure apparatus according to an embodiment of the present invention, illustrating an external view thereof.

FIG. 2 is an enlarged cross-sectional view of a photosensitive material.

FIG. 3 illustrates a peeling unit, illustrating a construction of a peeling section thereof.

FIGS. 4A to 4D illustrate a peeling process of a support medium by an adhesive roll.

FIG. 5 is a perspective view of a scanner used in the exposure apparatus shown in FIG. 1.

FIG. 6A is a plan view of a photosensitive material, illustrating exposed regions formed thereon.

FIG. 6B illustrates an arrangement of exposing areas of exposure heads.

FIG. 7 is a perspective view of an exposure head used in the exposure apparatus shown in FIG. 1, illustrating a schematic construction thereof.

FIG. 8 is a cross-sectional view of the exposure head shown in FIG. 7 in the sub-scanning direction along the optical axis, illustrating the construction thereof.

FIG. 9 is a partially enlarged view of a digital micro-mirror device (DMD).

FIGS. 10A and 10B illustrate operation of the DMD.

FIG. 11 illustrates a construction of a scanner provided with a nozzle for jetting an inert gas.

### BEST MODE FOR CARRYING OUT THE INVENTION

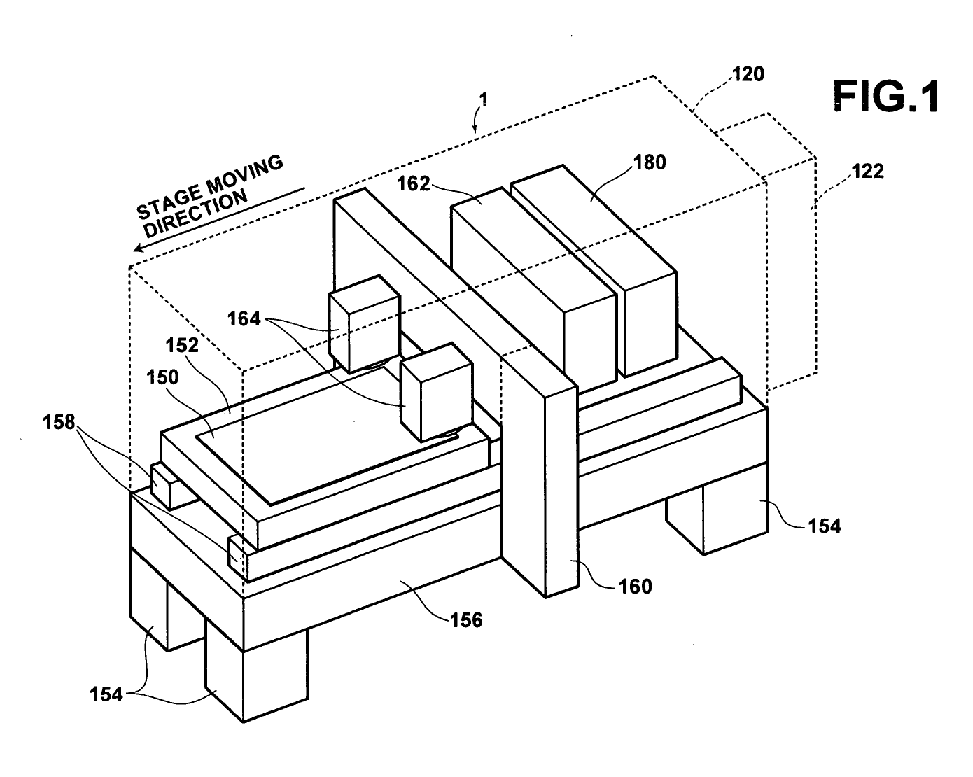

Hereinafter, exemplary embodiments of the present invention will be described with reference to the accompanying drawings. FIG. 1 is a perspective view of the exposure apparatus according to an embodiment of the present invention, illustrating an external view thereof. As illustrated, the exposure apparatus 1 of the present embodiment includes a plate-like stage 152 for holding thereon a sheet-like substrate by suction. Two guides 158 extending along the moving direction of the stage are provided on the upper surface of a thick plate-like mounting platform 156 which is supported by four legs 154. The stage 152 is arranged such that its longitudinal direction is oriented to the moving direction of the stage, and movably supported by the guides 158 to allow back-and-forth movements. Note that the exposure apparatus 1 also includes a not shown drive unit for driving the stage 152 along the guides 158.

An inverse U-shaped gate 160 striding over the moving path of the stage 152 is provided at the central part of the mounting platform 156. Each of the ends of the inverse U-shaped gate 160 is fixedly attached to each of the sides of the mounting platform 156. A scanner 162 and a peeling unit 180 are provided on one side of the gate 160, and a plurality of detection sensors 164 (e.g. two) for detecting the front and rear edges of the photosensitive material 150 is provided on the other side. The scanner 162 and detection sensors 164 are fixedly attached to the gate 160 above the moving path of the stage 152. The peeling unit 180 is attached to the gate 160 through the scanner 162 and fixedly disposed above the moving path of the stage 152. Note that the scanner 162, detection sensors 164, and peeling unit 180 are connected to a not shown controller that controls them.

A cover 120 for isolating the photosensitive material 150 from the atmosphere is provided over the mounting platform 156. The stage 152, the guides 158, a portion of the gate 160, scanner 162, detection sensors 164, and peeling unit 180 are provided within the cover 120. A vacuum pump 122 for reducing the air pressure within the cover 120 is connected to the cover 120. The vacuum pump 122 is controlled by a not shown controller to reduce the air pressure within the cover to the extent that the oxygen pressure adjacent to the photosensitive material 150, after the support medium 43 is peeled therefrom, is less than or equal to 80% of the atmospheric oxygen pressure.

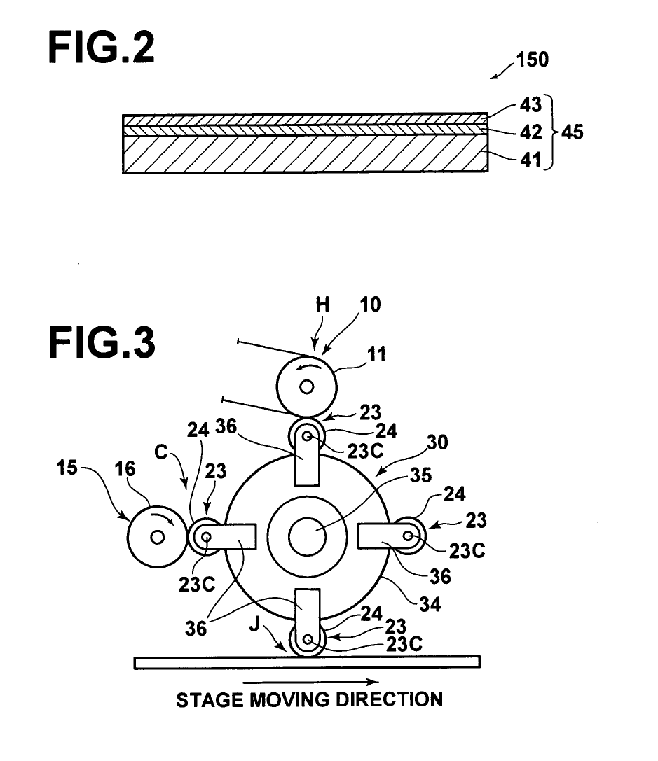

FIG. 2 is an enlarged cross-sectional view of the photosensitive material 150 used in the present embodiment. As illustrated, the photosensitive material 150 includes a photosensitive film 45 and a substrate 41. The photosensitive film 45 includes a resist layer 42, which is a photosensitive layer that solidifies when exposed to light, and a support medium 43 stacked on top of another, and the resist layer 42 of the photosensitive film 45 is applied to the substrate 41. The substrate 41 is made of glass, and the support medium is a film made of PET resin.

Hereinafter, the peeling unit 180 will be described.

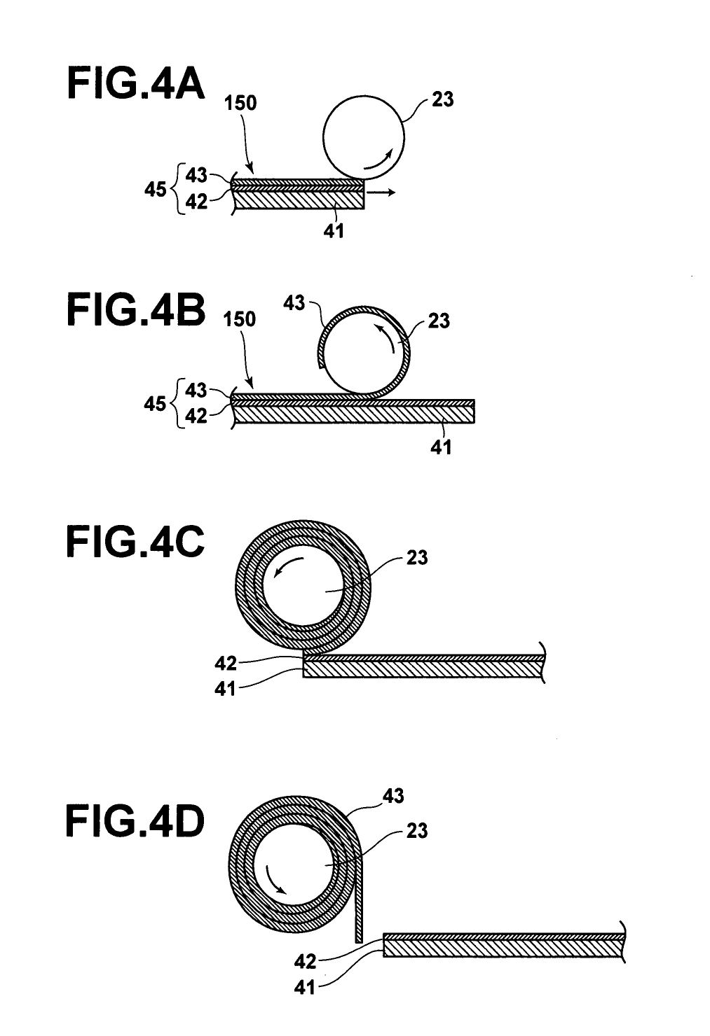

FIG. 3 illustrates the peeling unit 180, illustrating a construction of a peeling section thereof. FIGS. 4A to 4D illustrate a peeling process of the support medium by an adhesive roll.

The peeling unit 180 includes four adhesive rolls 23, each having an outer circumference face 24 made of an adhesive material, and an adhesive roll rotationally moving section 30 having the adhesive rolls 23 around a rotary shaft 35, like an observation wheel, such that each of the adhesive roll 23 is rotatable around each spindle 23C, and rotationally moving each adhesive roll 23 around the rotary shaft 35.

The peeling unit further includes: a support medium removal section 10 for removing the support medium from an adhesive roll 23, which has performed a peeling operation and rolled up the support medium around it, and a cleaning section 15 for cleaning the adhesive roll 23 removed of the support medium.

The adhesive roll rotationally moving section 30 is disposed on the upper side of the conveyor path of the photosensitive material 150, and includes a pair of turret plates 34 disposed opposite to each other, each at each end of the width direction of the photosensitive material 150. The rotary shaft 35 is rotated by a not shown rotary motor and rotatably supports the turret plates 34 through not shown bearings.

Four protruding legs 36 are disposed evenly spaced apart in the peripheral portion of each of the turret plates 34, and an adhesive roll 23 is rotatably supported by a spindle between the top portions of opposing legs 36 such that the adhesive roll is brought into contact with the width direction of the photosensitive material 150. A support medium removing roll 11 of the support medium removal section 10 is formed of a highly adhesive material, for example, it is formed by applying a highly adhesive agent on the outer circumference face. In the adhesive roll rotationally moving section 30, the support medium removing roll 11 is disposed right above the rotary shaft 35 (support medium removing position H in FIG. 3) so as to be accessible to each adhesive roll 23 from above, and structured to be rotated by a not shown drive section in the counterclockwise direction in FIG. 3 (arrow direction in FIG. 3). Thus, the support medium 43 peeled by each adhesive roll 23 and rolled up around the outer circumference face thereof is stuck to the support medium removing roll 11, approaching from above, at the support medium removing position H, and peeled from the outer circumference face of the adhesive roll 23.

A cleaning roll 16 forming the cleaning section 15 is positioned right beside the rotary shaft 35, i.e., positioned at the same level when FIG. 3 is viewed edge-on, and upstream of each adhesive roll 23 in the conveying direction of the photosensitive material 150, i.e., disposed upstream of a peeling position J. The cleaning roll 16 is rotated, by a not shown drive section, in the clockwise direction in FIG. 3, and brought into plane contact with each adhesive roll 23 peeled of the support medium 43 by the support medium removing roll 11, from the horizontal direction to remove dirt and dust adhered on the surface of each adhesive roll 23, thereby maintaining or improving the adhesion.

Next, a structure of the scanner 162 will be described.

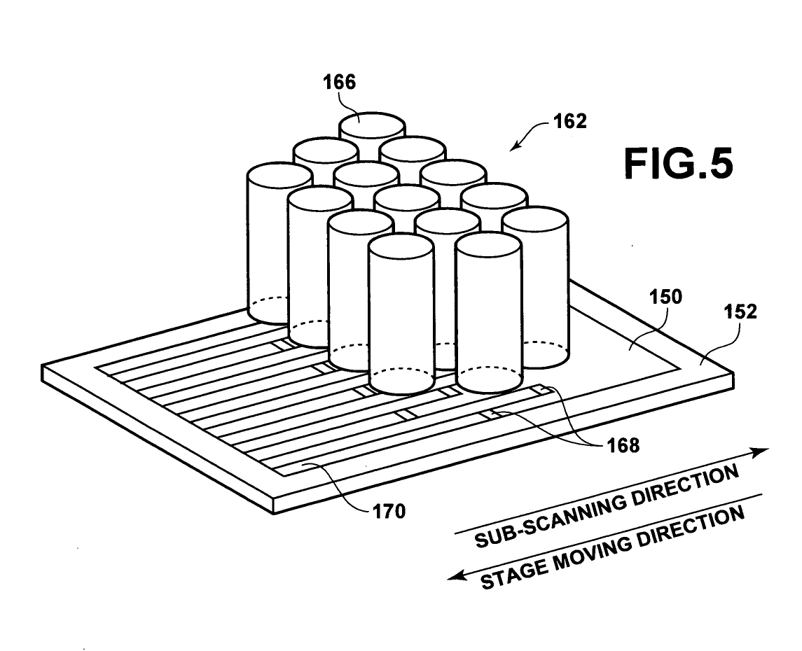

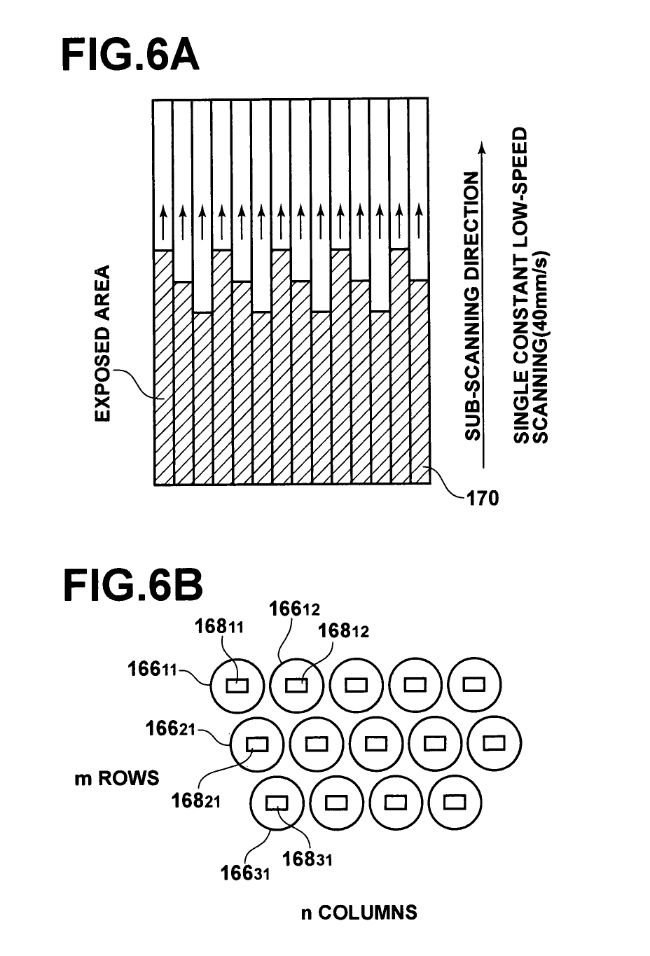

As illustrated in FIGS. 5 and 6B, the scanner 162 has a plurality of exposure heads 166 (e.g., 14) disposed in substantially a matrix form of “m” rows with “n” columns. In this example, four exposure heads 166 are disposed in the third row in relation to the width of the photosensitive material 150. Hereinafter, the exposure head disposed at the n^{th} column of the m^{th} row will be designated as exposure head 166ₘₙ.

The exposure area of an exposure head 166 has a rectangular shape with a short side oriented in the sub-scanning direction. Accordingly, a stripe-shaped exposed area 170 is formed on the photosensitive material 150 by each of the exposure heads 166 as the stage 152 is moved. Hereinafter, the exposure area of the exposure head disposed at the n^{th} column of the m^{th} row will be designated as the exposure area 168ₘₙ.

As illustrated in FIGS. 6A and 6B, each of the exposure heads disposed in a line in each row is shifted in the arrangement direction at a predetermined distance (product of the long side of the exposure area multiplied by a natural number, which is 2 in the present embodiment), so that the stripe-like exposed areas 170 are formed side by side without any gap between them in the direction orthogonal to the sub-scanning direction. Thus, the unexposed area between the exposure area 168₁₁ and 168₁₂ in the first row may be exposed by the exposure area 168₂₁ in the second row and the exposure area 168₃₁ in the third row.

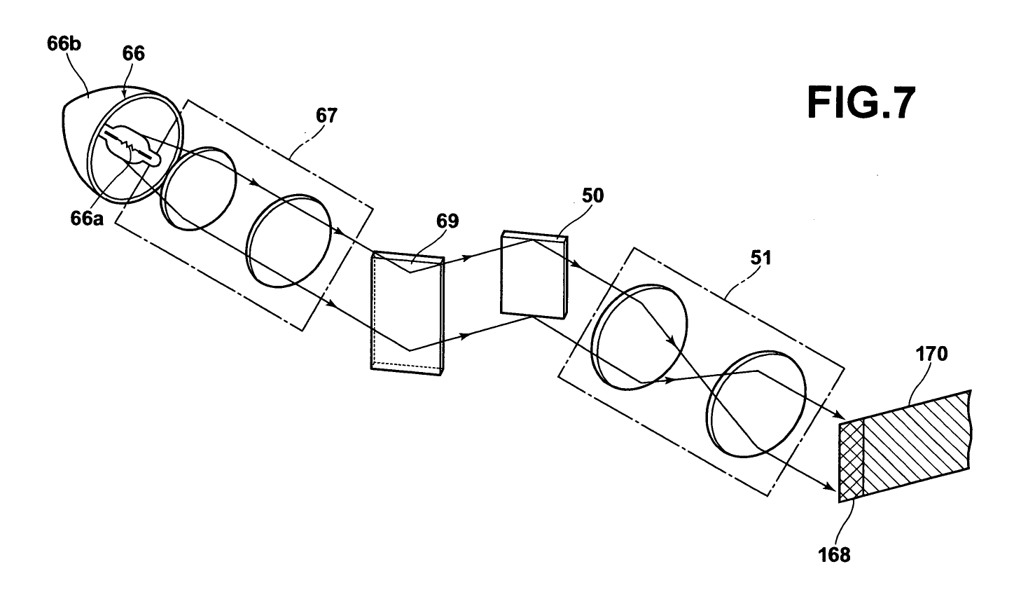

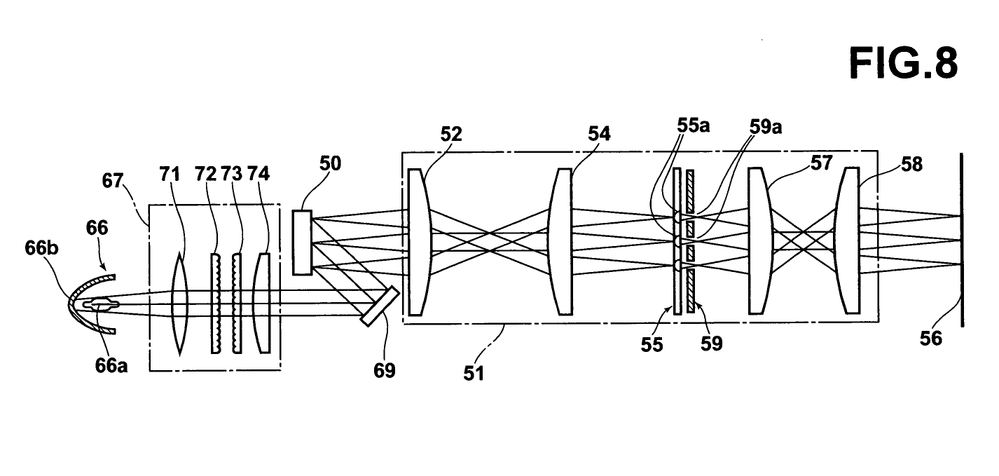

As illustrated in FIGS. 7 and 8, each of the exposure heads 166₁₁ to 166ₘₙ includes a digital micro-mirror device (DMD) 50, as a spatial optical modulation device for modulating an inputted light beam for each pixel according to image data. The DMD 50 is connected to a not shown controller which includes a data processing unit and a mirror drive control unit. The data processing unit of the controller generates a control signal for drive controlling each micro-mirror within a region of the DMD 50 to be controlled, with respect to each exposure head 166, based on inputted image data. Description of the region of the DMD 50 to be controlled will be provided later. Based on the control signal generated by the data processing unit, the mirror control unit controls the reflection surface angle of each micro-mirror of DMD 50, with respect to each exposure head 166. The description of how to control the reflection surface angle will be provided later.

A mercury lamp 66, a lens system 67 for focusing light emitted from the mercury lamp 66 on the DMD 50, after correcting light intensity distribution thereof, and a mirror 69 for reflecting the light transmitted through the lens system 67 toward the DMD 50 are disposed in this order on the light input side of the DMD 50. Note that the lens system 67 is depicted schematically in FIG. 7.

As illustrated in FIG. 8, the lens system 67 includes; a collimator lens 71 for collimating light emitted from a filament 66a of the mercury lamp 66 and collected on the front side by a reflector 66b; a micro-fly-eye lens 72 disposed in the optical path of the light transmitted through the collimator lens 71; another micro-fly-eye lens 73 disposed in opposite to the micro-fly-eye lens 72, and a field lens 74 disposed on the front side of the micro-fly-eye lens 73, i.e., on the side toward the mirror 69. Each of the micro-fly-eye lenses 72 and 73 includes multitudes of microscopic lens cells disposed vertically and horizontally. The light transmitted through each of the microscopic lens cells is inputted to the DMD 50 by overlapping with each other, so that the light intensity distribution of the light irradiated on the DMD 50 is equalized.

In the mean time, a lens system 51 for focusing light, reflected by the DMD 50, on the scanning surface (exposure surface) 56 of the photosensitive material 150 is disposed on the light reflection side of the DMD 50. The lens system 51 is disposed such that the DMD 50 and exposure surface 56 are in conjugated relationship. The lens system 51 is depicted schematically in FIG. 7, but as illustrated in detail in FIG. 8, it includes: a magnifying imaging optical system of two lenses 52, 54; an imaging optical system of lenses 57, 58; a micro-lens array 55; and an aperture array 59. The micro-lens array 55 and an aperture array 59 are disposed between the two imaging optical systems. The micro-lens array 55 includes multitudes of micro-lenses, each corresponding to each pixel of the DMD 50. The aperture array 59 includes multitudes of apertures 59a, each corresponding to each micro-lens 55a of the micro-lens array 55.

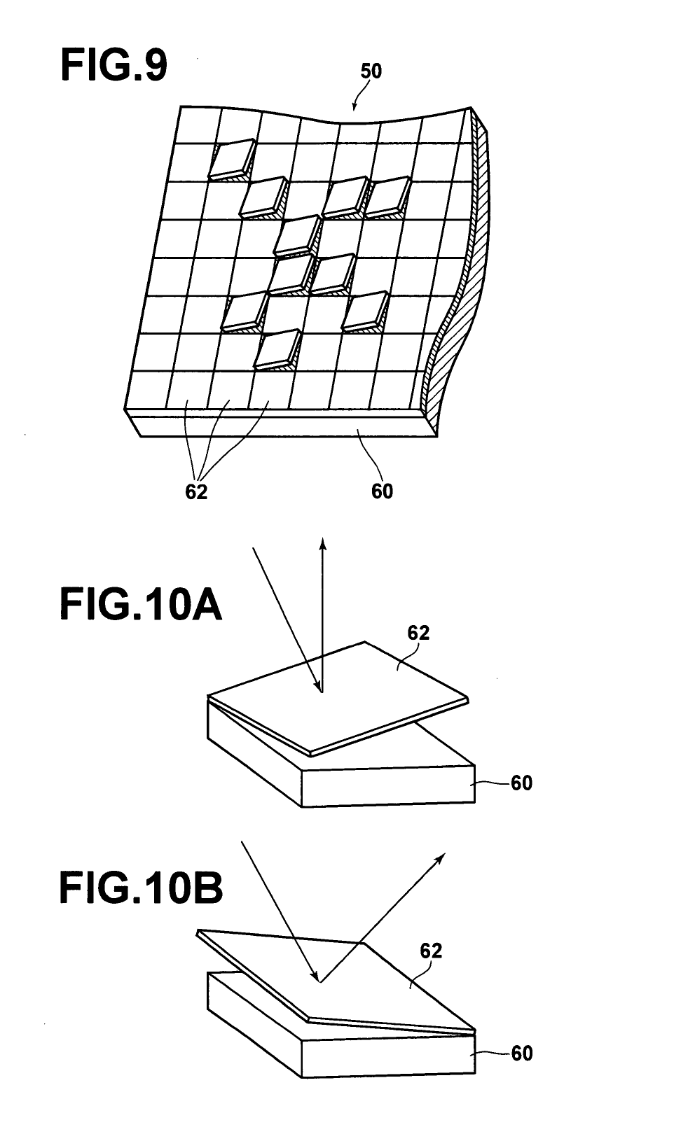

The DMD 50 includes tiny mirrors (micro-mirrors) 62 supported by support posts on SRAM cells (memory cells) 60, as illustrated in FIG. 9. It is a mirror device in which multitudes of tiny mirrors, constituting pixels, are arranged in a lattice pattern (e.g., 600×800). Each pixel has a micro-mirror 62 at the top supported by the support post, and a material having a high reflectance, such as aluminum or the like, is vapor deposited on the surface of the micro-mirror 62. The reflectance of the micro-mirror 62 is greater than or equal to 90%. A silicon-gate CMOS SRAM cell 60, which may be produced on a common manufacturing line for manufacturing semiconductor memories, is provided beneath each of the micro-mirrors 62 through the support post including a hinge and a yoke. The entire DMD is constructed monolithically.

When a digital signal is written into the SRAM cell 60 of the DMD 50, the micro-mirror 62, supported by the support post, is inclined within the range of ±α degrees (e.g., ±10 degrees) centered on the diagonal line relative to the substrate on which the DMD 50 is mounted. FIG. 10A illustrates a micro-mirror 62 inclined by +α degrees, which means that the micro-mirror 62 is in on-state, and FIG. 10B illustrates a micro-mirror 62 inclined by −α degrees, which means that the micro-mirror 62 is in off-state. Accordingly, by controlling the inclination of the micro-mirror 62 in each pixel of the DMD 50 according to image signals, in the manner as illustrated in FIG. 9, the light inputted to the DMD 50 is reflected to the inclination direction of each micro-mirror 62.

FIG. 9 is a partially enlarged view of the DMD 50, illustrating an example state in which some of the micro-mirrors of the DMD 50 are controlled to incline by + or −α degrees. The on-off control of each of the micro-mirrors 62 is performed by a not shown controller connected to the DMD 50. A light absorption material (not shown) is disposed in the direction to which light beams are reflected by off-state micro-mirrors 62.

Next, an operation of the exposure apparatus according to the present embodiment will be described. A peeling operation for peeling off a support medium 43 performed by the peeling unit 180 will be described first.

The air pressure within the cover 120 is reduced by driving the vacuum pump 122 to the extent that the oxygen pressure adjacent to the photosensitive material 150, after the support medium 43 is peeled therefrom, is less than or equal to 80% of the atmospheric oxygen pressure.

The stage 152, carrying thereon the photosensitive material by suction, is moved along the guides 158 from upstream of the gate 160 to down stream at a constant speed by a not shown drive unit. When the stage 152 passes under the peeling unit 180, a peeling operation for peeling the support medium 43 is performed.

As illustrated in FIGS. 4A to 4D, an adhesive roll 23 rotates in the illustrated arrow direction, and starts peeling the support medium 43, constituting the photosensitive material 150, conveyed by the stage 152 by suction (FIG. 4A). Thereafter, the adhesive roll 23 continues peeling the support medium 43 by pressing the photosensitive material 150 and rolling up the peeled support medium 43 (FIG. 43B). By conveying the photosensitive material 150 to the upstream end in the conveying direction thereof, the entire support medium 43 is peeled from the photosensitive material 150 by the adhesive roll 23 (FIG. 4C) . Note that the rear end of the support medium 43 entirely peeled off and rolled up around the adhesive roll 23 is hanging downward, as illustrated in FIG. 4D. This hanging rear end of the support medium 43 is grasped, and the support medium 43 is removed from the adhesive roll 23 in the support medium removal section 10. Thereafter, the surface of the adhesive roll 23 is cleaned up in the cleaning section 15. The photosensitive material 150 peeled of the support medium 43 is further conveyed, sucked on the stage 152, toward the scanner 162.

An operation of the scanner 162 will now be described.

Light emitted from the mercury lamp 66 illustrated in FIGS. 7 and 8, having a wavelength, for example, in the range from 360 to 420 nm range is irradiated on the DMD 50, after equalized in light intensity distribution through the lens system 67 as described above. Image data corresponding to the exposure pattern is inputted to a not shown controller connected to the DMD 50, and tentatively stored in a frame memory in the controller. The image data are data representing the density of each pixel forming an image in a binary value (presence or absence of dot).

When the stage 152, carrying thereon the photosensitive material 150 peeled of the support medium 43, passes under the gate 160, the fore edge of the photosensitive material 150 is detected by the sensors 164 attached to the gate 160. Then, the image data stored in the frame memory are sequentially read out for several lines at a time, and a control signal for each exposure head 166 is generated by the data processing unit based on the readout image data. Then each of the micro-mirrors of the DMD 50, with respect to each exposure head 166, is on-off controlled by the mirror drive control unit support based on the generated control signal.

While the light from the mercury lamp 66 is irradiated on the DMD 50, the light beam reflected by an on-state micro-mirror of the DMD 50 is condensed by the lens system 51 and focused on an exposure surface 56 of the photosensitive material 150. In this way, the light emitted from the mercury lamp 66 is on-off controlled by each of the micro-mirrors of the DMD 50, and the photosensitive material 150 is exposed at a unit of pixels (exposure area 168) substantially identical to the number of pixels used in the DMD 50. Further, movement of the photosensitive material 150 at a constant speed with the stage 152 causes the photosensitive material 150 to be sub-scanned by the scanner 162 in the direction opposite to the moving direction of the stage 152, and a stripe-shaped exposed region 170 is formed by each exposing head 166.

When the sub-scanning of the photosensitive material 150 by the scanner 162 is completed, and the rear edge of the substrate 150 is detected by the detection sensors 164, the stage 152 is returned to the original position on the uppermost stream of the gate 160 along the guides 158 by a not shown drive unit. Thereafter, it is moved again along the guides 158 from upstream to downstream of the gate 160 at a constant speed. Note that the exposed photosensitive material 150 is developed and etched, and thereby a wiring pattern is formed.

In this way, in the present embodiment, the peeling unit 180 is provided upstream of the scanner 162 of the exposure apparatus 1 in the conveying direction of the photosensitive material 150, so that the photosensitive material 150 peeled of the support medium 43 may be exposed immediately thereafter. This may reduce the time, as much as possible, the resist layer 42 of the photosensitive material 150 peeled of the support medium 43 is exposed to the atmosphere. As a result, the reaction of the resist layer 42 with oxygen may be minimized. Thus, degradation in sensitivity of the resist layer 42 to light may be prevented, and a pattern exposure by the scanner 162 may be performed satisfactorily.

In particular, by reducing the oxygen pressure adjacent to the photosensitive material 150, after the support medium 43 is peeled therefrom, to less than or equal to 80% of the atmospheric oxygen pressure, the reaction of the resist layer 42 with oxygen may be reduced further.

In the embodiment described above, the oxygen pressure adjacent to the photosensitive material 150, after the support medium 43 is peeled therefrom, is reduced to less than or equal to 80% of the atmospheric oxygen pressure by reducing the air pressure within the cover 120 by the vacuum pump 122. Alternatively, the oxygen pressure adjacent to the photosensitive material 150, after the support medium 43 is peeled therefrom, may be reduced to less than or equal to 80% of the atmospheric oxygen pressure by jetting an inert gas, such as a nitrogen gas or the like, onto the photosensitive material 150, after the support medium 43 is peeled therefrom.

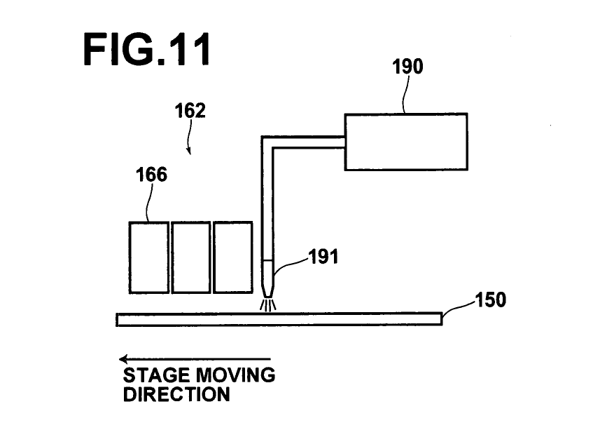

In this case, as illustrated in FIG. 11, an inert gas supply unit 190, and a nozzle 191, connected to the inert gas supply unit 190, for jetting an inert gas are provided. Then, the inert gas supply unit 190 is drive controlled by a not shown controller to jet an inert gas from the nozzle 191 toward the photosensitive material 150 so that the oxygen pressure adjacent to the photosensitive material 150, after the support medium 43 is peeled off, becomes less than or equal to 80% of an atmospheric oxygen pressure.

By jetting an inert gas toward the photosensitive material in the manner as described above, the oxygen pressure adjacent to the photosensitive material 150, after the support medium 43 is peeled off, may also be reduced to less than or equal to 80% of the atmospheric oxygen pressure. This may further reduce the reaction of the resist layer 42 with oxygen.

Further, a photosensitive material 150 for printed wiring board is used in the embodiment described above. But for a photosensitive material for producing a color filter of a liquid crystal panel formed of a glass substrate, as the substrate, and a color filter film, as the photosensitive layer, stacked on top of another, a predetermined pattern may be exposed on the color filter film immediately after the support medium is peeled therefrom, as in the embodiment described above.

Still further, in the embodiment described above, a pattern is exposed using a light beam. But a configuration may be adopted in which a mask having a transparent section corresponding to a pattern to be exposed and a surface light source are used, and light emitted from the surface light source is irradiated on the photosensitive material 150 through the mask to exposed the pattern on the photosensitive material 150.

Further, in the embodiment described above, a mercury lamp is used as the light source of the exposure apparatus 1, but a laser light source may also be used.

Still further, in the embodiment described above, an exposure apparatus for performing an exposure on a printed wiring board is described, but the present invention is not limited to this. It will be appreciated that the exposure apparatus of the present invention may be applied for exposing display materials, including color filters, pillar materials, lib materials, spacers, partitions, and the like, or exposing recording media for patterning, including holograms, micromachines, proofs, and the like.

Further, the present invention is not limited to the embodiment described above, and various changes and modifications may be made without departing from the spirit of the invention, such as an exposure apparatus that employs a laser light source, and an AOM and a polygon mirror, as optical scanning optical system, which perform light modulation of the leaser light source, as described, for example, in Japanese Unexamined Patent Publication No. 2000-227661.

1. An exposure apparatus, comprising:
an exposure means for exposing a predetermined pattern on a photosensitive layer of a plate-like laminated body formed by applying a photosensitive film, which is formed of the photosensitive layer and a support medium stacked on top of another, on a substrate with the photosensitive layer toward the substrate;
a conveyor means for conveying the plate-like laminated body to the exposure means along a predetermined conveying path; and
a peeling means, provided upstream of the exposure means in the predetermined conveying path, for peeling the support medium from the plate-like laminated body.

2. The exposure apparatus according to claim 1, further comprising an oxygen pressure reducing means for reducing the oxygen pressure adjacent to the photosensitive layer, after the support medium is peeled therefrom, to less than or equal to 80% of the atmospheric oxygen pressure.

3. The exposure apparatus according to claim 2, wherein the oxygen pressure reducing means is a means for reducing the air pressure within the apparatus.

4. The exposure apparatus according to claim 2, wherein the oxygen pressure reducing means is a means for jetting an inert gas toward the plate-like laminated body.

5. The exposure apparatus according to claim 1, wherein the exposure means includes a digital micro-mirror device.

6. The exposure apparatus according to claim 5, wherein the digital micro-mirror device is a device in which the reflection surface angle of each micro-mirror is controlled according to the predetermined pattern.
